(19) United States
(12) Patent Application Publication
(10) Pub. No.: US 2016/0110261 A1
(43) Pub. Date: Apr. 21, 2016

(54) CLOUD STORAGE USING MERKLE TREES

(71) Applicant: Axcient, Inc., Mountain View, CA (US)

(72) Inventors: Nitin Parab, Palo Alto, CA (US); Aaron Brown, Sunnyvale, CA (US)

(21) Appl. No.: 14/977,607

(22) Filed: Dec. 21, 2015

Related U.S. Application Data
(63) Continuation-in-part of application No. 13/889,164, filed on May 7, 2013.

(51) Int. Cl. G06F 11/14; G06F 17/30; H04L 9/08

(52) U.S. Cl. CPC G06F 11/1453; H04L 9/0894; G06F 17/30327; G06F 17/30318

(57) ABSTRACT

Efficient cloud storage systems, methods, and media are provided herein. Exemplary methods may include storing a data stream on a client side de-duplicating block store of a client device, generating a data stream Merkle tree of the data stream, storing a secure hash algorithm (SHA) key for the data stream Merkle tree, as well as the data stream Merkle tree on the client side de-duplicating block store, recursively iterating through the data stream Merkle tree using an index of a snapshot Merkle tree of the client device that is stored on a cloud data center to determine missing Merkle nodes or missing data blocks which are present in the data stream Merkle tree but not present in the snapshot Merkle tree stored on the cloud data center, and transmitting over a wide area network (WAN) the missing data blocks to the cloud data center.

### CROSS REFERENCE TO RELATED APPLICATIONS

This application is a continuation-in-part of U.S. application Ser. No. 13/889,164, filed on May 7, 2013 titled “CLOUD STORAGE USING MERKLE TREES”, which is hereby incorporated by reference herein in its entirety, including all references and appendices cited therein.

### FIELD OF THE INVENTION

The present technology may be generally described as providing systems and methods for transmitting backup objects over a network, and specifically efficiently transmitting large backup objects.

### BACKGROUND

Transmitting an object, such as a file, across a network usually requires the transmission of all blocks of data for the object to a block store. A unique identifier may be assigned to the object when it is stored on the block store. This unique identifier allows for subsequent retrieval of the object from the block store at a later point in time.

### SUMMARY OF THE PRESENT TECHNOLOGY

According to some embodiments, the present technology may be directed to method of transmitting an object over the network to a deduplicating storage system that uses Merkle Tree representations for objects stored therein.

According to some embodiments, the present technology may be directed to methods that comprise: (a) storing a data stream on a client side de-duplicating block store of a client device; (b) generating a data stream Merkle tree of the data stream; (c) storing a secure hash algorithm (SHA) key for the data stream Merkle tree, as well as the data stream Merkle tree on the client side de-duplicating block store; (d) recursively iterating through the data stream Merkle tree using an index of a snapshot Merkle tree of the client device that is stored on a cloud data center to determine missing Merkle nodes or missing data blocks which are present in the data stream Merkle tree but not present in the snapshot Merkle tree stored on the cloud data center; and (e) transmitting over a wide area network (WAN) the missing data blocks to the cloud data center.

According to some embodiments, the present technology may be directed to systems that comprise: (a) a processor; (b) logic encoded in one or more tangible media for execution by the processor and when executed operable to perform operations comprising: (i) locating a Merkle tree of a stored object on a deduplicating block store; (ii) comparing an object at a source location to the Merkle tree of the stored object; (iii) determining changed blocks for the object at a source location; and (iv) transmitting a message across a network to the deduplicating block store, the message including the change blocks and Merkle nodes that correspond to the change blocks.

According to some embodiments, the present technology may be directed to systems that comprise: (a) a cloud data center comprising a cloud side de-duplicating block store; and (b) a client side appliance that is coupled to the cloud data center over a wide area network (WAN), the client side appliance being configured to: (1) store a data stream on a client side de-duplicating block store of a client device; (2) generate a data stream Merkle tree of the data stream; (3) store a secure hash algorithm (SHA) key for the data stream Merkle tree, as well as the data stream Merkle tree on the client side de-duplicating block store; (4) recursively iterate through the data stream Merkle tree using an index of a snapshot Merkle tree of the client device that is stored on a cloud data center to determine missing Merkle nodes or missing data blocks which are present in the data stream Merkle tree but not present in the snapshot Merkle tree stored on the cloud data center; and (5) transmit over the wide area network (WAN) the missing data blocks to the cloud a center.

According to some embodiments, the present technology may be directed to a non-transitory machine-readable storage medium having embodied thereon a program. In some embodiments the program may be executed by a machine to perform a method that includes: (a) storing a data stream on a client side de-duplicating block store of a client device; (b) generating a data stream Merkle tree of the data stream; (c) storing a secure hash algorithm (SHA) key for the data stream Merkle tree, as well as the data stream Merkle tree on the client side de-duplicating block store; (d) recursively iterating through the data stream Merkle tree using an index of a snapshot Merkle tree of the client device that is stored on a cloud data center to determine missing Merkle nodes or missing data blocks which are present in the data stream Merkle tree but not present in the snapshot Merkle tree stored on the cloud data center; and (e) transmitting over a wide area network (WAN) the missing data blocks to the cloud data center.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary architecture in which embodiments of the present technology may be practiced;

FIG. 2 illustrates exemplary logic utilized by the present technology to perform PUSH and BULK_PUSH operations;

FIG. 3 illustrates exemplary logic utilized by the present technology to perform POP operations from that remove Merkle nodes (e.g., hashes) from a stack;

FIG. 4 illustrates exemplary logic utilized by the present technology to perform a Merkle tree copy;

FIG. 5 illustrates the use of an exemplary stratum Merkle tree;

FIG. 6 is a flowchart of an exemplary method for transmitting changed blocks of an object over a network using Merkle trees;

FIG. 7 illustrates an exemplary computing system that may be used to implement embodiments according to the present technology;

FIG. 8 is a schematic diagram of another example architecture that can be used to implement aspects of the present technology;

FIG. 9 is a flowchart of an example method for storing a data stream;

FIGS. 10A-E collectively illustrate an example Merkle tree synchronization process using directed acyclic graphs;

FIGS. 11A-C are example pseudocode implementations of PUSH, POP, and PUT services;

FIG. 12 is a flowchart of an example Merkle tree synchronization method;

FIG. 13 is a flowchart of another example method for storing a data stream and synching the data stream with a snapshot stored in a cloud data center using Merkle optimized transmission over a WAN; and

FIG. 14 illustrates an example garbage collection process, illustrating concurrently the services, generation timeline, and blob processes involved in the garbage collection process.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology may provide end-to-end deduplication of data by exporting the Merkle Tree via an application programming interface (“API”) used to store/transfer objects into the storage system. In some instances, deduplication may include the creation of Merkle trees that represent an object. These Merkle trees may be exported as a storage API.

The present technology provides methods of transmitting objects from a source to a destination, where the destination storage system is a deduplicating storage system that uses Merkle Tree representations to describe objects. More specifically, the present technology specifies an application programming interface (API) for transferring an object more efficiently by, for example, avoiding transmitting chunks of the object that already exist at the destination storage system. An exemplary API exploits the hierarchical nature of the Merkle Tree to reduce the number of round trip messages required by first determining chunks of the object, which already exists at the destination storage system. The present technology extends a Merkle Tree based deduplicating storage system by performing deduplication of data while transmitting the data to the storage system.

A destination cloud-based block store may internally store data in a deduplicating fashion where unique chunks of objects are stored only once. The API of the destination block store may internally store objects in a deduplicated manner such that only unique chunks of the objects are stored and the object is described using a Merkle Tree. As background, a destination cloud-based block store may be referred to as a De-Duplicating Block Store. In some instances, the deduplicating block store may store unique blocks of data. The block store may provide a simple API to provide the following functionalities: (i) PUT: store a block of data with a uniform hash as the key; (ii) GET: read a block with given the uniform hash; (iii) EXIST: lookup if a block with given that the uniform hash already exists. The block store supports for reference count or garbage collection for reclamation of space by unused blocks. It is noteworthy that this block store itself can be viewed as a key-value store where the key is the uniform hash of the block and the value is the data of the block.

In some instances, Merkle trees may be utilized in conjunction with de-duplicating block stores. In some instances, any given stream of data can be stored into a block store as follows: (i) split the stream on chunks of data, store each chunk of data in the block store with the uniform hash of the block as key and take the uniform hash of an extent (continuous blocks) of the stream store in the block store as a block. The uniform hash of this block now represents the entire extent. Similarly, the uniform hashes of continuous extents may be stored as a block, getting back a new uniform hash that represents part of the stream containing those extents. The Merkle tree is built using the aforementioned steps until is a single uniform hash is generated that represents the entire stream. Thus, the identity of an extent, comprised of one or more data blocks, is the hash of the contents of the deepest branch node in which the entire extent is descended. Such an identity of a whole or branch of a Merkle tree is therefore reproducible given the same extent of data. If the blocks are stored into the blocks store in a bottom to top manner such that no Merkle block is stored before storing all the blocks it refers, such an invariant allows the system to assume that if an EXIST check on Merkel root uniform hash returns true, it can be assumed all its children will also return true for their respective EXIST checks. Representing a data stream using Merkel tree provides support for most normal stream operations like (i) read a stream sequentially or randomly; (ii) update a stream giving a new Merkel root for the stream; (iii) concatenate of streams to give a Merkel root for concatenated stream; and so forth. Note that update of a stream is a copy-on-write operations since it will generate a new uniform hash Merkel root.

With regard to the present technology, the Merkle trees may be utilized in transmitting changed blocks over a network. In some instances, changed blocks of an object may be detected by walking a Merkle tree or a plurality of Merkle trees for an object and determining changed blocks. These changed blocks may be transmitted over the network to a block store as well as corresponding Merkle nodes that represent these changed blocks. Using the changed blocks and Merkle nodes, the changed blocks may be incorporated into the block store. These and other advantages of the present technology will be discussed in greater detail herein.

Generally, the present technology provides for a bandwidth optimized, cloud-based object store. The present technology allows for efficient transfer of object/stream of data from client to the cloud data center in a bandwidth optimized fashion. For example, the present technology reduces the transmission (e.g., transfer) of chunks of data that already exists in the data center. The solution is to deploy above de-duplicating object store both on the client side and in the cloud.

In some instances, methods employing the present technology include a step of storing an object in the client side de-duplicating object store and copying a Merkle tree from the client side block store to a data center side block store. The present technology may determine if the blocks of the stream on the client side already exist in the data center and avoid sending them if the blocks do, in fact, exist. Storing the object in the blockstore using a Merkle tree also provides the additional advantage of checking if a larger extent of the stream containing more than one blocks already exists in the data center. Again, it can be assumed that if an exist check on Merkle root uniform hash returns true than all its children will also return true for exist checks.

The straight-forward algorithm to copy a Merkle tree from source blockstore to destination blockstore is to start from the uniform hash of the root of the Merkle tree and check if it exists in the destination blockstore. If the uniform hash of the root of the tree exists it can be safely assumed that the entire tree exists. If not, a check should be executed against each of the SAH1s contained in the root Merkle node to determine if they exist in the destination blockstore. This method continues down the tree recursively following the paths that don't exist until the system reaches leaves that don't exist. Leaves that don't exist may be PUT in the destination blockstore. One may then reconstruct the entire tree in the destination blockstore. Note that a Merkle block cannot be put into the block store before all of its children all the way down to the root data blocks are put into the system (this is the sequentially consistent requirement for Merkle heads). Thus this straight forward algorithm has to first descend to the leaves (note each EXISTS call is a message over the WAN) and then PUT (again call over the WAN) blocks bottom up from leaves up to the root Merkle.

The algorithm walks the tree breadth first and pushes all non-existent nodes at a level onto the stack. At the leaf level all the non-existent data blocks are put into the data store. After that, the stack is popped with each node on the stack put into the datastore. Thus an operation to transfer a new version of an object that differs by a single block will result into 2× (height of the tree) calls over the WAN. A WAN optimized algorithm avoids the second set of PUT calls by building the stack on the data center side and then making a single new API call to PUT all the nodes that are to be transferred, while maintaining the sequentially consistent requirement for Merkle heads. If the stack is built at the destination, then the Merkle blocks can be sent only once during the EXISTS check and pushed into the stack at the same time. The WAN optimized copy of Merkle tree protocol defines PUT, GET, EXISTS messages with equivalent bulk variants, which work only on data blocks. The protocol exports the concept of a “group” allowing for a flush/commit operation/message, which guarantees that all previous PUTS in the group are synced, similarly to a write barrier but limited to the group. For Merkle blocks the protocol defines PUSH and POP messages along with bulk variants. Each Merkle tree copy operation may be performed in the context of a single group.

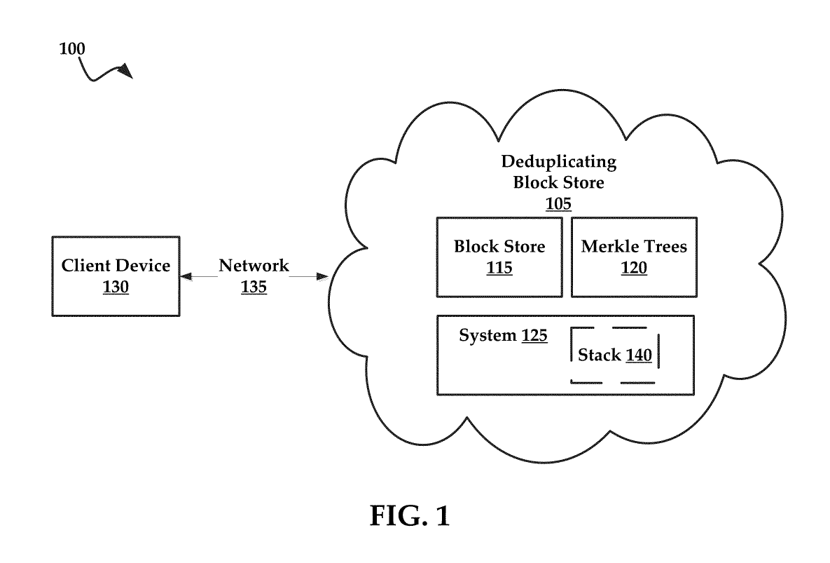

These and other advantage of the present technology will be described below with reference to the drawings (e.g., FIGS. 1-7).

Referring now to the drawings, and more particularly, to FIG. 1, which includes a schematic diagram of an exemplary architecture 100 for practicing the present invention. Architecture 100 may include a block store 105. In some instances, the block store 105 may be implemented within a cloud-based computing environment. In general, a cloud-based computing environment is a resource that typically combines the computational power of a large model of processors and/or that combines the storage capacity of a large model of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of servers, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

In some instances the block store 105 may include a deduplicating block store 115 that stores blocks of data for one or more objects, such as a file, a group of files, or an entire disk. Additionally the block store 105 may comprise Merkle trees 120 that include hash-type representations of objects within the deduplicating block store 115. That is, for each object (or group of blocks), a Merkle tree exists that represents the blocks of the object.

According to some embodiments, the deduplicating block store 115 may include immutable object addressable block storage. The deduplicating block store 115 may form an underlying storage foundation that allows for the storing of blocks of objects. The identifiers of the blocks are a unique representation of the block, generated for example by using a uniform hash function. The present technology may also use other cryptographic hash functions that would be known to one of ordinary skill in the art with the present disclosure before them.

The architecture 100 may include a deduplication system, hereinafter referred to as system 125 that generates Merkle trees that represent the objects stored in the deduplicating block store 115. Once the Merkle tree for the object has been created, the Merkle tree may be exposed to a client device 130 via an API. The client device 130 may use the API to determine changed blocks for an object and/or transmit the changed blocks to the deduplicating block store 115. In some instances the client device may include an end user computing system, an appliance, such as a backup appliance, a server, or any other computing device that may include objects such as files, directories, disks, and so forth.

In some instances the API may encapsulate messages and their respective operations, allowing for efficient writing of objects over a network, such as network 135. In some instances, the network 135 may comprise a local area network (“LAN”), a wide area network (“WAN”), or any other private or public network, such as the Internet. In some instances the API may utilize various commands such as PUT, GET, and EXIST. The EXIST command allows the system 125 to determine if a block exists in the deduplicating block store 115, as will be described in greater detail below.

According to some embodiments, the API supports two ‘methods’ of transferring an object using Merkle tree semantics. For example, in some embodiments the API may use a reduced number of messages (round trips) but may require buildup of a state stack 140 on the system 125 side. In other embodiments the API may use relatively more messages (round trips) but the state stack 140 may be built on the client device 130. Either of these methods provides improved cloud storage (or within dedicated block stores such as various storage media) of objects due to significant reductions in the amount of data transferred to the deduplicating block store 115.

The system 125 may utilize Merkle tree synchronization to facilitate transmission of blocks to the deduplicating block store 115 via the network 135. In general, the Merkle tree synchronization used by the system 125 may allow for relatively lower latency (e.g., less chatty protocols) and improved pipeline utilization compared to current cloud storage method and systems. Additionally, the system 125 may provide progress indicators that provide information indicative of the transfer of changed blocks over the network 135 to the deduplicating block store 115.

Generally, the system 125 may generate a Merkle tree for an object. The Merkle tree may be passed to the block store 105. The Merkle tree for the object is then exposed to the client device as an API or protocol that can be used to determine changes in an object relative to a backup of the object store in the deduplicating block store 115. In some instances, the backup of the object may include a snapshot of the object.

In accordance with the present disclosure, semantics utilized by the system 125 provide that if an EXIST call on a Merkle block returns ‘true’, then the whole tree relative to any Merkle block as root (e.g., parent Merkle node) is considered to exist. Thus, a block store associated with a Merkle node cannot be put into the deduplicating block store 115 before all of the blocks associated with children Merkle nodes are placed into the deduplicating block store 115. In other words, the system 125 may rely on sequential consistency of Merkle nodes within a Merkle tree when analyzing any Merkle node head within the Merkle tree. The system 125 may facilitate a Merkle tree copy from one datastore to another, in a bottom-to-top manner so as to not break the above semantic requirements.

In some instances, the algorithm utilized by the system 125 walks the Merkle tree breadth first and pushes all missing (e.g., non-existent) nodes at a given level of the Merkle tree onto a stack 140. Again, the stack 140 may exist on the block store 105 or the client device 130.

At the leaf level, all the missing data blocks may be put into the deduplicating block store 115. Subsequently, the stack 140 can be popped with each node on the stack put into the block store 105. It is noteworthy that even if a stack is built, a sync or copy protocol used by the system 125 should begin at a root node and proceed downwardly though the Merkle tree in a top-to-bottom manner, performing EXIST checks on all Merkle nodes in the Merkle tree. If the system 125 determines Merkle nodes that exist, the system 125 may avoid sending these existing subtrees to the block store 105. The term “existing” should be understood to include nodes that are substantially identical (e.g., not a changed or new node).

If the stack 140 is built at the client device 130 the Merkle nodes may be sent twice. The Merkle nodes may be sent once to allow the system 125 to perform top-to-bottom EXIST checks on each Merkle node within a Merkle tree and once for popping the stack 140 for synchronization with the block store 105.

However, if the stack 140 is built at the block store 105 the Merkle blocks may be sent only once during EXIST checks and pushed into the stack 140 at the same time. According to some embodiments the stack 140 serves another purpose in that it catalogs work to be performed to sync a Merkle Tree from the client device 130 to block store 105. The system 125 may enable a “progress indicator” that represents the stack 140.

According to some embodiments, the protocols used by the system 125 may define PUT, GET, and EXIST messages with equivalent bulk variants which work on data blocks. The protocol may be used to export the concept of a “group,” allowing for a flush and/or commit operation (e.g., message) which guarantees that previous PUTS in the group are synced. This functionality is similar to a write barrier but limited to the group. For Merkle blocks the protocol defines PUSH and POP messages along with bulk variants. Each Merkle tree copy operation may be executed in the context of a single group.

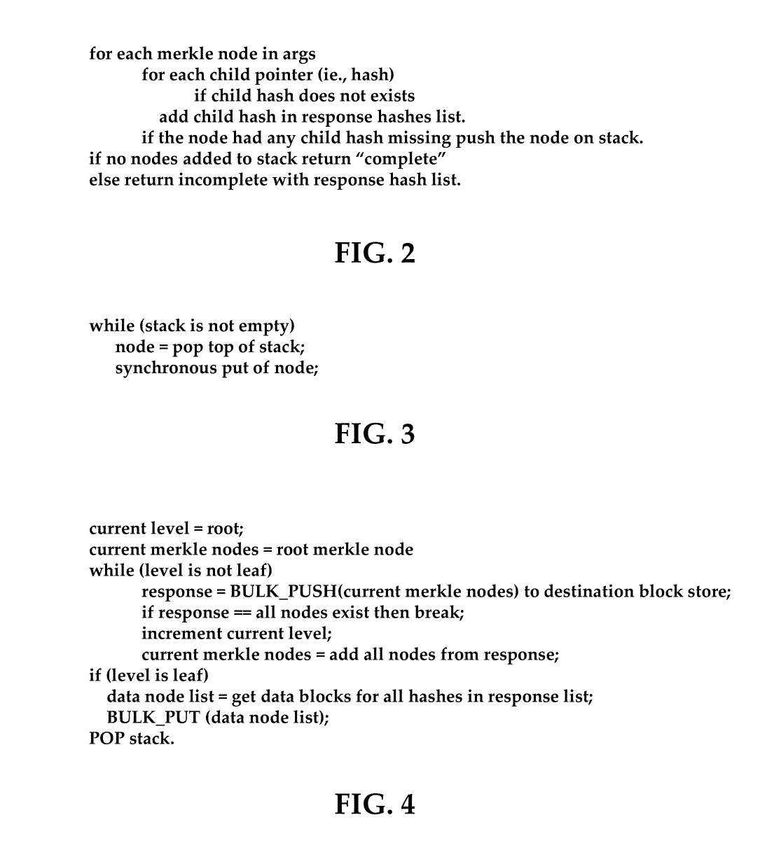

FIG. 2 illustrates exemplary logic utilized by the system 125 to perform PUSH and BULK_PUSH operations. This exemplary logic allows the system 125 to evaluate Merkle nodes in a Merkle tree and determine if a child hash (e.g., child Merkle node) does not exist. If a child hash does not exist in the system 125 then the system 125 adds the child hash to a hash list. Additionally, if a Merkle node has a missing child hash, the system 125 may push the Merkle node onto a stack. Once the Merkle tree has been processed, the system 125 may return a response hash list to the client device 130.

FIG. 3 illustrates exemplary logic utilized by the system 125 to perform POP operations that remove Merkle nodes (e.g., hashes) from a stack 140. Working on a last in-first out manner, the system 125 may POP a Merkle node on the top of the stack 140 and put the Merkle node on the stratum block store, synchronously. It will be understood that the system 125 may perform these POP and PUT operations while the stack 140 includes at least one Merkle node therein.

FIG. 4 illustrates exemplary logic utilized by the system 125 to perform a Merkle tree copy. In general, the system 125 may look at a root Merkle node in a Merkle tree and process the remaining Merkle nodes in a bottom-to-top manner. The system 125 may BULK-PUSH current Merkle nodes to the stratum block store in some instances. If the system 125 determines that all Merkle nodes exist, then the system 125 ignores these Merkle nodes. That is, the system 125 deduplicates the blocks of data using the Merkle tree. Only when Merkle nodes are non-existent are the blocks of data that correspond to the Merkle nodes (and potentially the child nodes of a Merkle node) transmitted over the network to the deduplicating block store 115.

Thus, when a non-existent Merkle node is detected, the system 125 may gather block(s) for the Merkle node (or all blocks for child Merkle nodes associated with the non-existent Merkle node) and POP the stack 140.

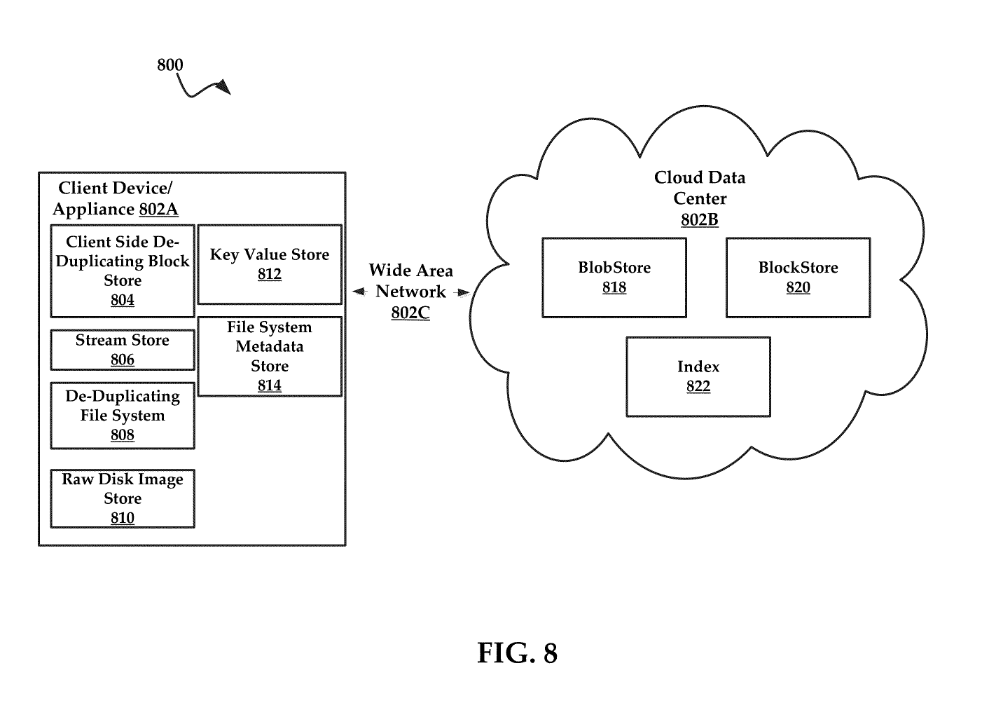

The system 100 of FIG. 1 maintains a per session state like the stack making the complete execution of a Merkle tree sync a statefull operation. Session oriented state full systems require more resources and are harder to scale. In contrast with the system 100 of FIG. 1, the system 800 of FIG. 8 operates in a stateless manner as it does not require a stack or a popping operation relative to the stack. The system 800 of FIG. 8 eliminates any need for having a stack on the server side and the POP API. The system 800 and its APIs are stateless which allows for the creation of scalable cloud replication services.

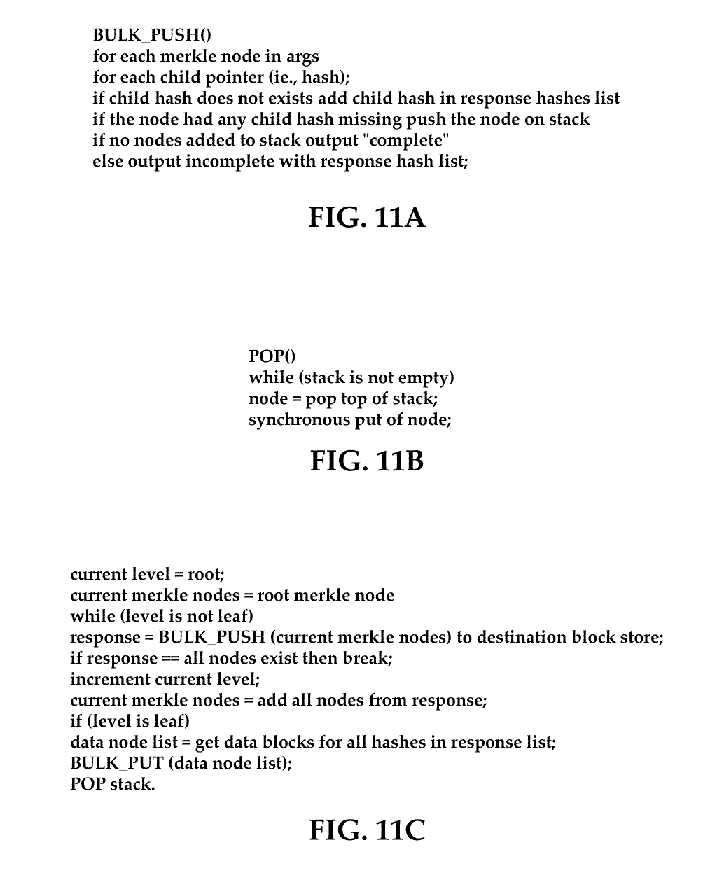

An example algorithm to copy a Merkel tree from the client side de-duplicating object store to the cloud side de-duplicating object store is illustrated in FIG. 11A-C.

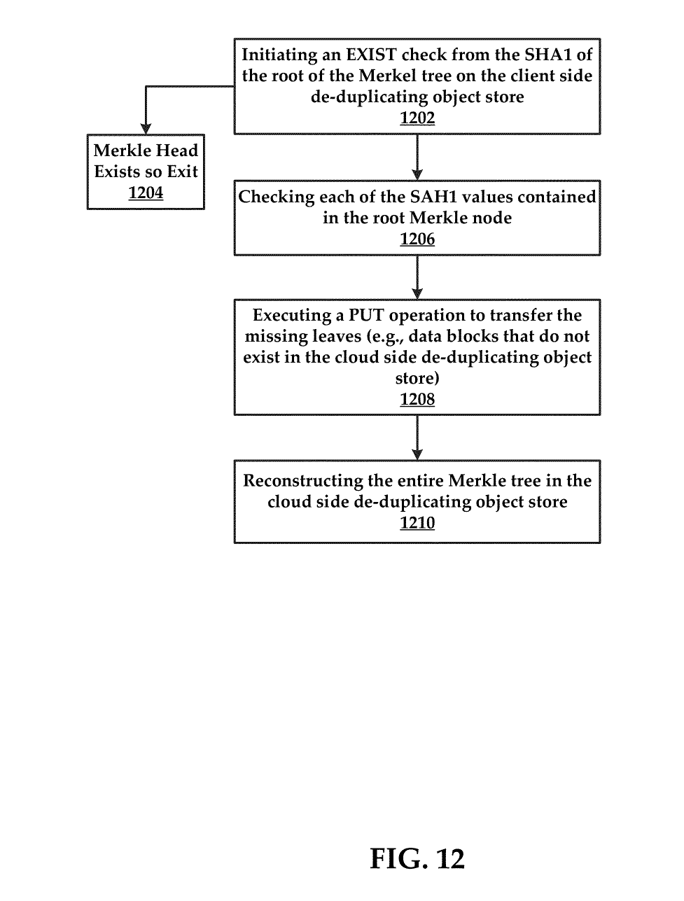

FIG. 12 illustrates an example synchronization method that begins by initiating 1202 an EXIST check from the SHA1 of the root of the Merkel tree on the client side de-duplicating object store. If the SHA1 of the root of the Merkle tree exists it can be safely assume that the entire Merkle tree exists and the process exits at step 1204. If the SHA1 of the root of the Merkle tree does not exist, it is then necessary for the method to include a step of checking 1206 each of the SAH1 values contained in the root Merkle node. For example, an EXIST operation is performed on each of these SHA1 values in the cloud side de-duplicating object store.

The process descends down the Merkle tree recursively following any paths that do not exist until the process reaches leaves that do not exist. Again, it will be understood that leaves are the actual blocks of data, rather than the Merkle nodes that are merely representative of the data (e.g., names of the leave blocks).

The process then includes executing 1208 a PUT operation to transfer the missing leaves (e.g., data blocks that do not exist in the cloud side de-duplicating object store). The process can then optionally include reconstructing 1210 the entire Merkle tree in the cloud side de-duplicating object store. It is noteworthy to mention that a Merkle block (node) cannot be put into the block store before all of its children (either Merkle nodes or ultimately leave(s)) all the way down to the data blocks (e.g., leaves) are put into the cloud side de-duplicating object store.

Thus, the process first descends to the leaves (note each EXISTS call is a message over the WAN) and then PUT (again call over the WAN) operations for blocks from the bottom up (e.g., from the leaves to the root Merkel node).

In some embodiments, the algorithm walks the Merkle tree breadth first and pushes all non-existent Merkle nodes on the same level onto the stack. At the leaf level (e.g., lowest data block level away from the root Merkle node) all the non-existent data blocks are put into the client side de-duplicating object store.

Next, the stack is popped with each Merkle node on the stack put into the client side de-duplicating object store. Thus an operation to transfer a new version of an object that differs by a single block will result in a two-fold (height of the Merkle tree) number of calls over the WAN.

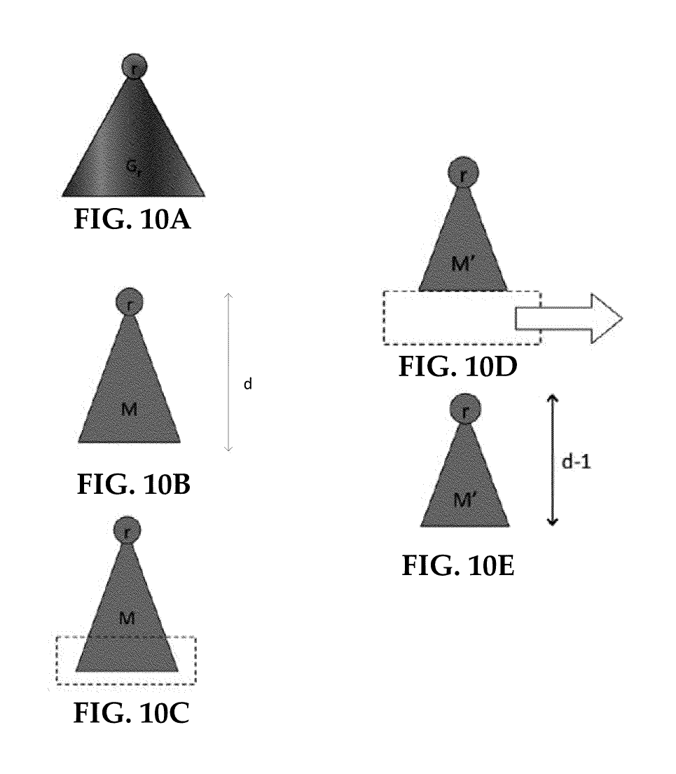

FIGS. 10A-E collectively illustrate an example stream synchronization process. Initially, a stream is defined by a root block R. The blocks (e.g., leaves) that are reachable from R form a directed acyclic graph GR. All the blocks in areas A and B exist on the client device and blocks in areas C and D exist on the cloud data store.

If blocks which are only present on the cloud data store are removed, a new directed acyclic graph M can be created as in FIG. 10B. All the remaining blocks are reachable from the root block R. Of note, the directed acyclic graph has an initial height of d.

FIG. 10C illustrates the selection of leaves of the graph M, which are blocks that can be added to the cloud data store without adding any other blocks first. In FIG. 10D, the leaves of M are transferred in parallel in multiple threads, although it will be understood that the leaves can be transferred in series. After the leaves have been transferred, a new directed acyclic graph M′ is created as illustrated in FIG. 10E. The height of M′ is one less than the height of M (e.g., d−1).

Blocks are pushed to the cloud data center using the same process, creating a new directed acyclic graph and pushing the lowest blocks to the cloud data center, until the root block R is reached.

The system 100 of FIG. 1 is WAN latency optimized as it requires half the number of API calls between client and server but is not scalable as it is state full session oriented. The system 800 of FIG. 8 requires double the number of API calls between client and server but is scalable as all its API calls are stateless.

According to some embodiments, a stratum may be used as the base of the data storage architecture utilized herein. The stratum may consist of a block store, such as deduplicating block store 115 and corresponding Merkle trees. The deduplicating block store 115 may be a content-unaware layer responsible for storing, ref-counting, and/or deduplication. The Merkle Tree data structures described herein may, using the deduplicating block store 115, encapsulate object data as a collection of blocks optimized for both differential and offsite tasks. The block store 105 provides support for transferring a Merkle tree (with all its data blocks) between the client device 130 and the block store 105. A block store on the client device may proactively send data blocks to the block store in order to provide low latency when the system 125 tries to send a block from the client device to the block store.

The stratum block store provides unstructured block storage and may include the following features. The block store may be adapted to store a new block and encrypt the block as needed using context and/or identifiers. The block store may also deduplicate blocks, storing each unique block only once. The block store may also maintain a ref-count or equivalent mechanism to allow rapid reclamation of unused blocks, as well as being configured to retrieve a previously stored block and/or determine if a block exists in the block store given a particular hash (e.g., Merkle node).

Various applications may store Merkle tree identifiers (e.g., root hashes) within a Merkle tree, thus creating a hierarchy building from individual file Merkles to restore point Merkles, representing an atomic backup set.

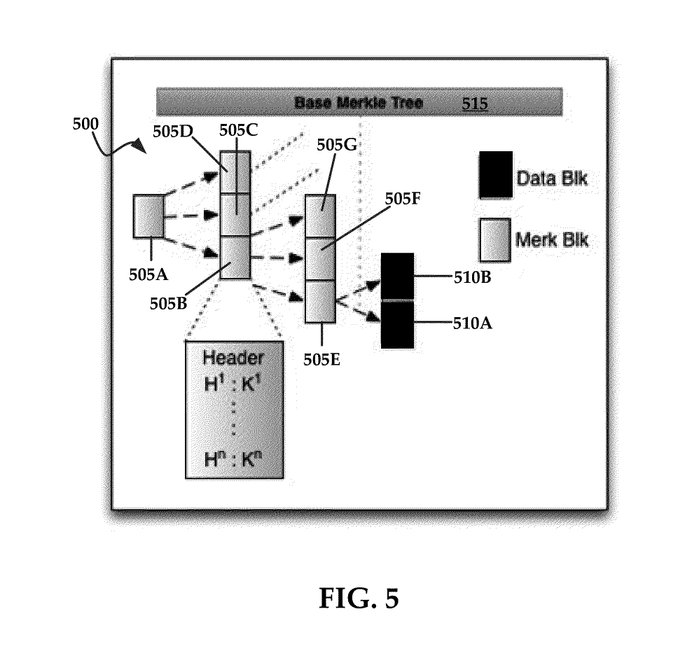

FIG. 5 illustrates the use of a second Merkle tree 500 that includes various Merkle nodes 505A-G, where 505A is a root Merkle node, 505B-D are child Merkle nodes of the root Merkle node 505A, and child Merkle nodes 505E-G are child Merkle nodes of the Merkle node 505B. Assuming that child Merkle node 505E is a non-existent node, the system may obtain data blocks 510A and 510E from a base Merkle tree. Again, the base Merkle tree was an initial Merkle tree generated for an object that is stored in a block store.

Again, the use of Merkle trees allows for efficient identification of differences or similarities between multiple Merkle trees (whole or partial). These multiple Merkle trees correspond to Merkle trees generated for an object at different points in time.

The identity property of any Merkle node relative to its child nodes provides an efficient method for identification of blocks which do not already exist on a remote system, such as a cloud block store. The Stratum Merkle functions utilized by the system 125 may export various interfaces to the client device. For example, the system 125 may allow for stream-based write operations where a new Merkle tree is constructed based on an input data stream. In other instances, the system may allow for stream-based read operations where data blocks described by the Merkle are presented sequentially.

In other instances, the system 125 may allow for random-based read operations of block in the block store by using arbitrary offset and size reads. Additionally, the system 125 may generate comparisons that include differences between two or more Merkle trees for an object.

The system 125 may allow for stream-based copy-on-write operations. For example, given an input data stream of offset and extent data and a predecessor Merkle tree, a new Merkle tree may be constructed by the system 125, which is equivalent to the predecessor modified by the change blocks in the input data stream.

In some instances the stratum Merkle tree uses a stratum block store to store its blocks, both data blocks and Merkle blocks (e.g. Merkle nodes). The blocks may be stored into the blocks store from the bottom up so that no Merkle block is stored before storing all the blocks to which it refers. This feature allows the Merkle tree layer and other layers using stratum block store to safely assume that if an EXIST check on a particular Merkle block returns true, all its children nodes will also return true for their EXIST checks. Thus, EXIST checks need not be performed on these child nodes, although in some instances, EXIST checks may nevertheless be performed.

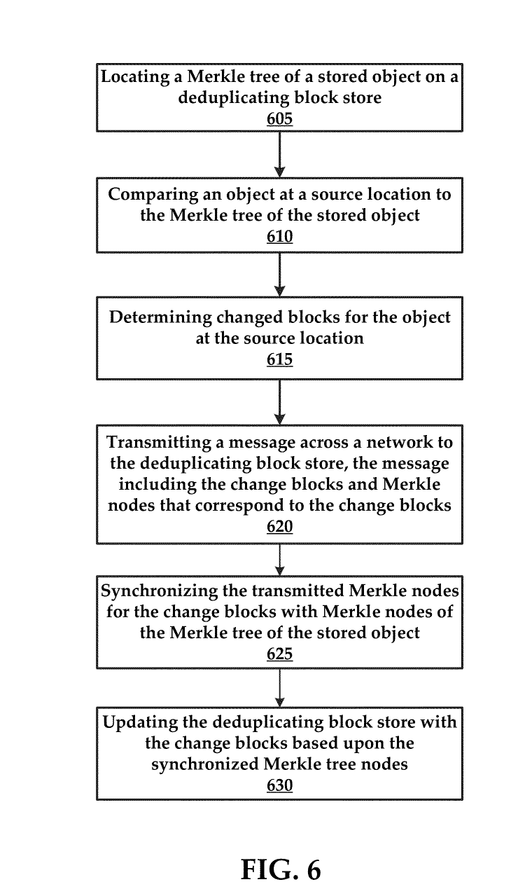

FIG. 6 is a flowchart of an exemplary method for transmitting changed blocks of an object over a network using Merkle trees. More specifically, the method may be generally described as a process for comparing an object at a source location to a Merkle tree representation of a previously stored version of the object on a deduplicating block store. This comparison allows for transmission of only changed blocks across the network for storage in the block store, thus preventing duplicate transmission of blocks that already exist on the data store.

The method may comprise a step 605 of locating a Merkle tree of a previously stored object on a deduplicating block store Merkle. The Merkle tree may comprise a hash table representation of blocks of data for the stored object. The Merkle tree for the object preferably comprises an object identifier that uniquely identifies the stored object within the deduplicating block store.

The method also comprises comparing 610 an object at a source location to the Merkle tree of the stored object. The object at the source location may include changed blocks compared to the stored object. Thus, the method may include a step 615 of determining changed blocks for the object at the source location. The system may correlate the object at the source location with the stored object on the deduplicating block store using the unique identifier assigned to the stored object.

Once changed blocks have been identified, the method may include a step 620 of transmitting a message across a network to the deduplicating block store, the message including the change blocks and Merkle nodes that correspond to the change blocks.

The method may also include 625 synchronizing the transmitted Merkle nodes for the change blocks with Merkle nodes of the Merkle tree of the stored object, as well as a step 630 of updating the deduplicating block store with the change blocks based upon the synchronized Merkle tree nodes.

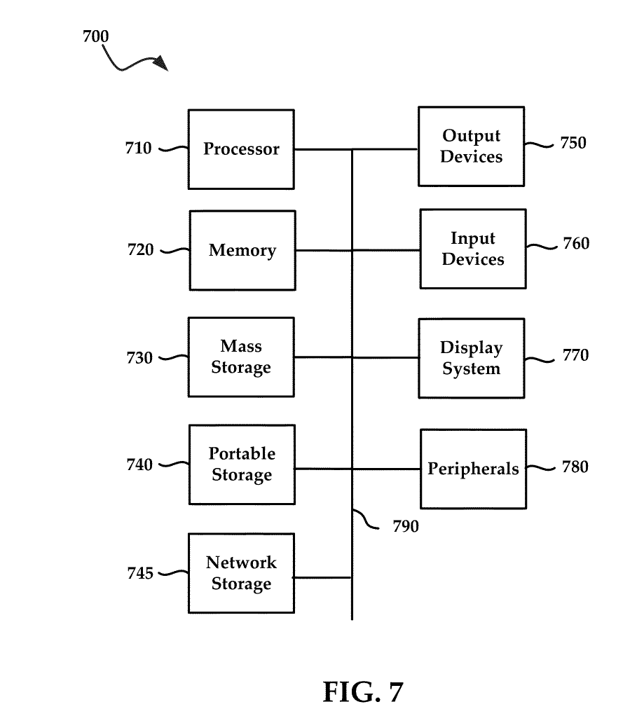

FIG. 7 illustrates an exemplary computing system 700 that may be used to implement an embodiment of the present technology. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 770, and other peripheral devices 780. The system 700 may also comprise network storage 745.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and graphics display 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present technology for purposes of loading that software into main memory 720.

Portable storage device 740 operates in conjunction with a portable non-volatile storage medium, such as a floppy disk, compact disk or digital video disc, to input and output data and code to and from the computing system 700 of FIG. 7. The system software for implementing embodiments of the present technology may be stored on such a portable medium and input to the computing system 700 via the portable storage device 740.

Input devices 760 provide a portion of a user interface. Input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Graphics display 770 may include a liquid crystal display (LCD) or other suitable display device. Graphics display 770 receives textual and graphical information, and processes the information for output to the display device.

Peripherals 780 may include any type of computer support device to add additional functionality to the computing system. Peripheral device(s) 780 may include a modem or a router.

The components contained in the computing system 700 of FIG. 7 are those typically found in computing systems that may be suitable for use with embodiments of the present technology and are intended to represent a broad category of such computer components that are well known in the art. Thus, the computing system 700 of FIG. 4 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

FIG. 8 illustrates an example appliance replication system 800 that is configured to allow for replication of multiple versions of multiple file systems. In general, the system 800 provides a unique storage and replication solution for storing frequent snapshots of a client device in the cloud using a transparent write back cache at the client device location. The write back operation is very efficient and completes very quickly. Stated otherwise, the system 800 provides a storage solution for storing onsite restore points and offsite restore points with very efficient and quick (WAN optimized data transfer) offsite process.

The system 800 allows for efficient replication between a client device 802A and a cloud data center 802B. The client device 802A and cloud data center 802B are communicatively coupled over a wide area network (WAN 802C). To be sure, the client device 802A can include a replication appliance that is coupled locally with a client such as a personal computer.

The system 800 in general comprises a client side de-duplicating block store 804, a stream store 806, a de-duplicating file system 808, a raw disk image store 810, a key-value store 812, and a file system metadata store 814.

In some embodiments, the client side de-duplicating block store 804 is configured to store unique blocks of data. The client side de-duplicating block store 804 provides a simple API (application programming interface) that allows for various functionalities. For example, the API provides a PUT functionality that stores a block of data with SHA1 (the Merkle node hash value of the block) as a key. The API also provides a GET functionality that reads a block and its associated SHA1 key. The API can also provide an EXIST function that executes a lookup to determine if a block with given SHA1 already exists. The client side de-duplicating block store 804 supports reference counting or garbage collection process for reclamation of space by unused blocks. Additional details regarding garbage collection processes will be described in greater detail below.

To be sure, the client side de-duplicating block store 804 itself can be viewed as a key-value store where the key is the SHA1 (hashed value or signature) of the block and the value is the data of the block.

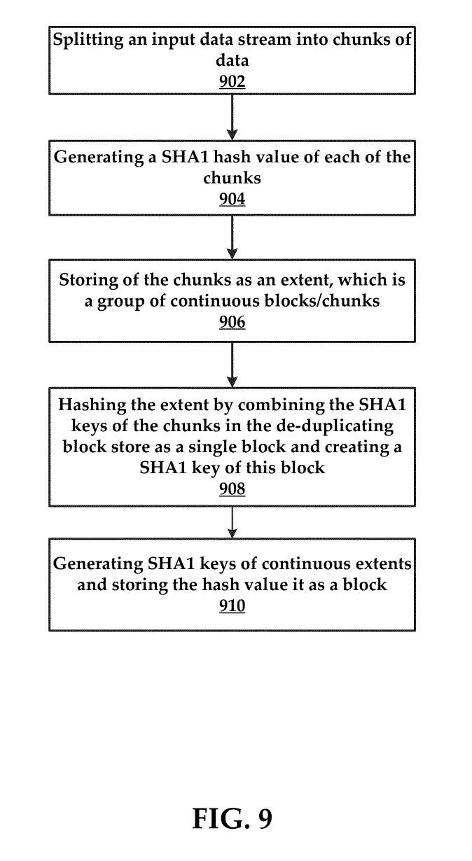

Referring briefly to FIG. 9, any given stream of data can be stored into the client side de-duplicating block store 804 using the method illustrated in FIG. 9. The method includes a step of splitting 902 an input data stream into chunks of data. The method includes generating 904 a SHA1 hash value of each of the chunks. Next, the method includes storing 906 each chunk of data in the de-duplicating block store 804 along with the SHA1 of the block as key.

The method also provides for storing 906 of the chunks as an extent, which is a group of continuous blocks/chunks. The method then includes hashing 908 the extent by combining the SHA1 keys of the chunks in the de-duplicating block store 804 as a single block and creating a SHA1 key of this block. To be sure, the SHA1 key value of this block now represents the entire extent and the SHA1 is a hash value of the other SHA1 keys.

In some embodiments, the method includes generating 910 SHA1 keys of continuous extents and storing the hash value it as a block. To be sure, the SHA1 value of this block represents part of the input stream containing those extents. This process continues until there is a single SHA1 value representing the entire input stream. Thus the identity of an extent, comprised of one or more data blocks, is the hash of the contents of the deepest branch node for which the entire extent is descended. Such an identity of a whole or branch of a Merkle tree is therefore reproducible given the same extent of data. If the blocks are stored into the block store from bottom up so that no Merkle block is stored before storing all the blocks it refers then this invariant allows the assumption that if an EXIST check on Merkel root SHA1 returns true then all its children will also return true for EXIST checks.

The ability to represent a data stream using Merkel tree supports additional stream operations such as reading a stream sequentially or randomly. It also supports updating of a stream, which would result in the generation of a new Merkel root for the stream. Also, it allows for a concatenation of streams to produce a Merkel root for the concatenated stream.

With respect to read operations, assuming that we know the SHA1 of the nth extent at the next level and also that the extents are of fixed size, this information can be used to obtain or read the SHA1 of an extent at a particular “extent size aligned offset” in the stream. It will be understood that the update of a stream is executed using copy-on-write operations since it will generate a new SHA1 Merkel root. By definition, the SHA1 Merkel root is the head node that represents the entirety of the input stream.

It will be understood that concatenation is natural operation of the encoding mechanism since the input stream can be thought of conceptually as a concatenation of extents/chunks.

Concatenation of streams can be used to encode a collection of streams where each stream is viewed as an extent of larger input stream. Note that in this larger stream of streams the individual extents (which are actually streams) will be extents of varying size. Given a SHA1 root hash value of a collection stream that is encoded as a concatenation of streams, the root SHA1 of any nth stream in the concatenation can be obtained.

According to some embodiments, the Merkle tree based de-duplicating object store 804 provides very efficient mechanisms of constructing and storing a new stream such that it is composed of full/partial other streams without writing any data but instead simply constructing a new Merkle tree.

The present technology provides a de-duplicating object store both on the client device and in the cloud data center. An example method is generally defined by two processes, namely the storing of an object on a client side de-duplicating object store and copying of a Merkel tree from client side de-duplicating object store to cloud side de-duplicating object store.

Referring back to FIG. 8, the cloud data center 802B can comprise, in some embodiments, a blobstore 818 and a blockstore 820 (referred to herein as the cloud side de-duplicating object store). The blobstore 818 is a lowest level of interface on which the entire cloud storage system is built. The interface provides basic features to read and write large blobs of data addressed by a key (e.g., SHA1 key value). The PUT interface exported by the blobstore 818 is asynchronous with callback. Additional details regarding the use of the PUT interface are provided infra.

Implementations of these interfaces will comprise adaptation layers to map a blobstore interface to the blob storage provider interface.

The blockstore 820 is a key-value store that stores the SHA1 key value of a block as key and the block data as its value. The internal implementation of the block store 820 stores the data separately from an index 822 that stores the SHA1 key values. The blocks of data are stored in a blob in the blobstore 818. A blob containing one or more data blocks is called a datablob. The index is a key value store with SHA1 key values as the key and a blobID of the datablob which contains the data block as the value. Thus a GET_block operation of the blockstore 820 is implemented as first a GET operation where the SHA1 key value in the index is used to return a blobid. A second GET operation is executed to using the SHA1 key in that datablob which returns the data for the block. It will be understood that the system can determine if a block exists in the blockstore. The system only has to only lookup the SHA1 key in the index.

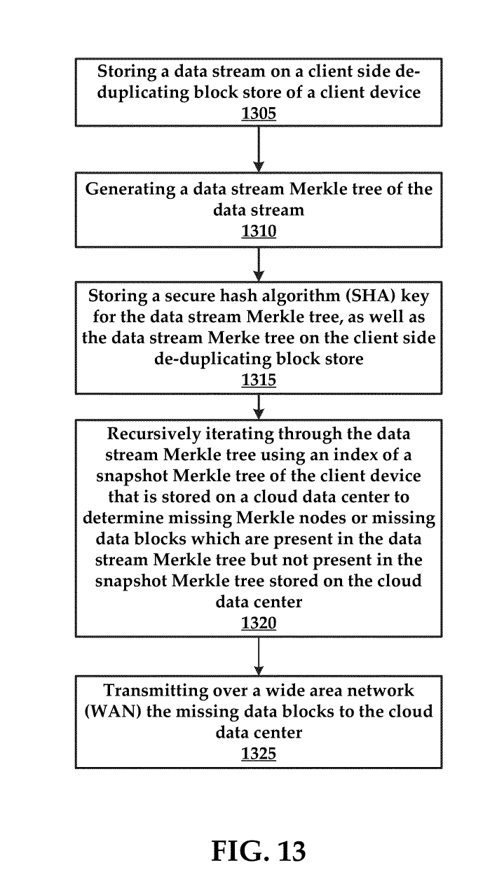

FIG. 13 illustrates an example method of synchronizing a data stream generated by a client with a snapshot of the client device stored on a cloud data center.

For context, the process assumes that a snapshot of a client device currently exists on the cloud data center. Also, a Merkle tree of the snapshot exists as well as a locality index.

The client device creates a data stream when an operation occurring on the client device modifies data on the client device. It will also be understood that the data to be synchronized can exist on a replication device or appliance that is coupled locally with the client device.

The method begins with a step of storing 1305 a data stream on a client side de-duplicating block store of a client device. Again, this client side de-duplicating block store can exist on a local replication appliance that is coupled to the cloud data center over a WAN.

Next, the method includes generating 1310 a data stream Merkle tree of the data stream. The method can also include a step of storing 1315 a secure hash algorithm (SHA) key for the data stream Merkle tree, as well as the data stream Merkle tree on the client side de-duplicating block store.

Two methods to synchronize the data stream Merkle tree with the cloud data center have been previously described.

In some embodiments, the present technology can be implemented to provide garbage collection services for cleaning the cloud data store.

A key challenge in implementation of a garbage collection process is to support online garbage collection. One problem is in how the system handles existing blocks being referred while garbage collection methods are in progress. Two example solutions are contemplated. First, the garbage collector can be configured to walk through all the Merkle roots only once and identify all the entries and will thus require marking on disk (such as disk writes). A second option is to configure the garbage collector to read through all the Merkle roots but mark in-memory (no disk writes) only a subset of blobs at a time and repeat it for all subsets of blobs in the Merkle tree.

In some embodiments, the garbage collector can mark all used blocks with a generation count. Also, a reference (EXISTS query) during garbage collection marks a block quarantine period. Used blocks are determined by walking through the Merkle tree of one or more (or all) snapshots of the file system. Thus, a mark operation by the garbage collector will require the file system to provide the “in-use” Merkle roots. The start and end of the mark period is notified to all encoders. The encoders are required to mark entries as being used.

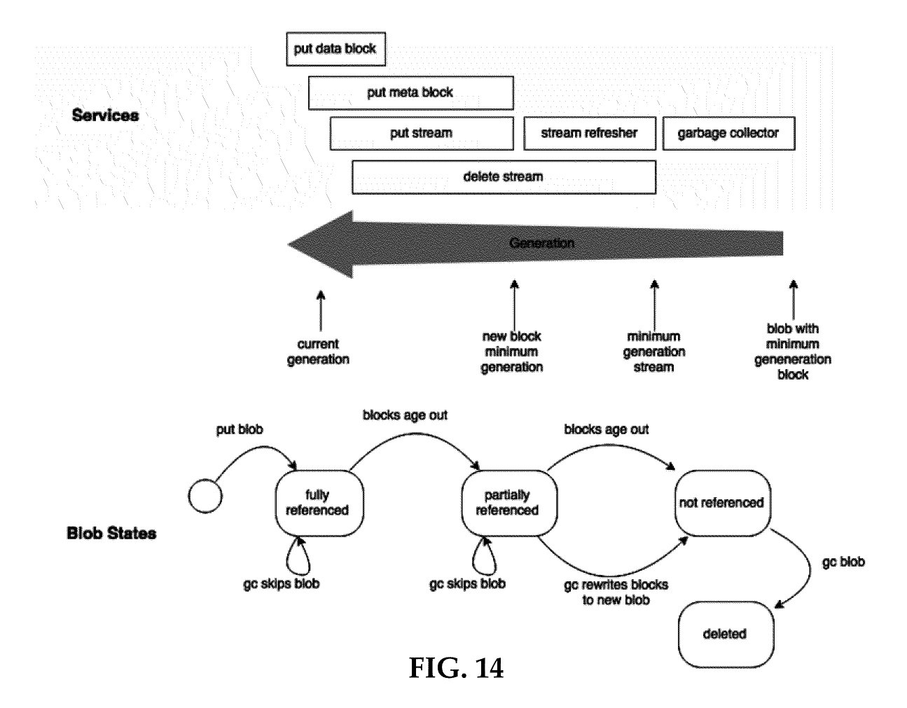

An example garbage collection process is illustrated in FIG. 14. For context, the garbage collection process depends on each block in a Merkle tree having a generation number that is provided by the garbage collector. The garbage collector examines blobs and removes blocks based on their assigned generation number. Block generation numbers are increased by the garbage collector during a refresh process. In some embodiments the generation number of a block is increased when the block is reference by a new stream or when it is refreshed by a stream refresher service.

Various PUT operations for placing data blocks, metadata blocks, and streams on the cloud data store occur initially. From a generation/age perspective, the current generation relates to the most recently transferred blocks. A current generation number is associated with each of these blocks in the PUT operations.

Blobs states associated with the PUT operations result in fully referenced blobs. The garbage collector will skip these blobs as they are new to storage.

A stream refreshing service is executed at some point in time after the PUT operations occur. The stream refreshing service can be used to determine which of the Merkle nodes in the Merkle tree are currently or recently in use or referenced by other blocks/nodes. If the blocks are old but are still in use or referenced by other blocks, the generation number for these blocks is refreshed. Again, it is noteworthy to mention that the generation number of any Merkle node is no greater than the generation number of any of its children (either Merkle node or data block). With respect to the generation timeline, partially referenced blocks can exist between a new block minimum generation time and a minimum generation stream time.

In terms of blobs, as the blocks age out and the blocks become partially referenced, the garbage collector will still skip the associated stored blobs because they are provided with a refreshed generation number.

At some point in time Merkle nodes or data blocks are no longer referenced as block age out further in time. The blocks now have a minimum generation number and their blobs are available for deletion by the garbage collector.

In sum, the garbage collection process is not only related to the age of the blocks and their blobs, but also the need for those blocks determined by whether the blocks are referenced by other blocks. If a block is no longer referenced by any other block, it can be assumed that it is no longer needed and can be deleted and its associated blob removed from the blobstore.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the framework module 120 may include separately configured web servers.

Example pseudo code for implementing the garbage collector service on the cloud data center is provided below.

The server stores three types of objects: data blocks, metadata blocks, and streams. Data blocks and metadata blocks are identified by the digest of the raw block data. Block data for metadata block contains a list of child block ids and a child type (data or metadata). Streams have arbitrary identifiers which are always chosen by the client. Streams are always added via put and removed via delete. While a stream exists, all blocks that it refers to directly or indirectly must be # retrievable via getDataBlocks or getMetaBlocks. Blocks added via putDataBlocks or putMetaBlocks may disappear at any time so long as the stream requirement above is maintained. Clients must handle blocks disappearing particularly when using the putMetaBlocks method.

class NodeUpdate: “““An update to node metadata using optimistic concurrency. If node metadata is modified elsewhere after this update is created, commit will fail.””” def_init_(self, store, identifier, new=False): self.state=IN_PROGRESS self.store=store self.identifer=identifier if new: self.old=DELETED else: self.old=self.store.get_node_metadata(self.identifier) self.new=self.old.copy( def set_generation(self, generation): assert self.state==IN_PROGRESS assert self.old==DELETED or self.old.generation<=self.new.generation self.new.generation=generation def set_blob(self, blob_identifier, blob_offset): assert self.state==IN_PROGRESS self.new.blob_identifier=blob_identifier self.new.blob_offset=blob_offset def delete(self): assert self.state==IN_PROGRESS self.new=DELETED def commit(self): “““Persist temporary metadata. If node metadata was modified elsewhere since it was read here, raise an exception.””” assert self.state==IN_PROGRESS if self.new==DELETED: if self.old==DELETED: ok =True else: ok=self.store.node_metadata_cond_del( key=self.identifier, old=self.old) else: if self.old==DELETED: ok=self.store.node_metadata_put_if_not_exist( key=self.identifier, new=self.new) else: ok=self.store.node_metadata_cond_put( key=self.identifier, old=self.old, new=self.new) if not ok: raise ConcurrentUpdateException( ) self.state=COMMITED class Node: “““ A node represents a block in the blockstore. Nodes together always form a DAG. identifier Secure hash of node data, assumed to be unique. kind Kind of data stored: data for raw data/leaf nodes, meta for internal nodes. kind and identifier form a key for the block index generation A generation number used for garbage collection. A node's generation must never decrease. Additionally, a node's generation is no greater than the generation of any of its descendants (reachable nodes). blob identifier blob offset ””” def_init_(self, store, identifier, data=None): self.store=store self.identifier=identifier self._data=data def data(self): “““Return raw data for this node””” if self._data is None: self._data=self.store.get_node_data(self.indentifier) return self._data def verify_data(self): “““Verify that data matches identifier””” return (secure_hash(self.data( ))==self.identifier) def optimistic_update(self): return NodeUpdate(self.store, self.identifier) def optimistic_create(self): return NodeUpdate(self.store, self.identifier, new=True) class DataNode: def kind( ): return “data” def children(self): return list( ) class MetaNode: def kind( ) return “meta” def children(self): if not self._children: kind, blockids= MetaNode._parse(self.data( )) self._children=list( ) for blockid in blockids: if kind==“data”: child=DataNode(blockid) elif kind==“meta”: child=MetaNode(blockid) self._children.append(child) return self._children def_parse(data): pass # return child type and children block ids def refresh(node, minimum, target): “““Refresh generation on node to be at least minimum. To mantain invariant, all descendants with generation less than minium are refreshed as well. Target is the new generation for refreshed leaf nodes. If this fails, a list of missing nodes is returned, otherwise an empty list is returned””” with node.optimistic_update( ) as update: if update.old is DELETED: # node does not exist in index update.abort( ) return None, [node] if update.old.generation( )<minimum: generation, missing= refresh_descendants(node, minimum, target) if generation: assert update.old.generation( )<=generation update.set_generation(generation) update.commit( ) return update.new.generation, missing else: # current node and all descendants have a generation at or above # minumum update.abort( ) return update.old.generation, list( ) def refresh_descendants(node, minimum, target): “““Like refresh, except the generation of node itself is not persisted.””” missing=list( ) generations=list( ) if len(node.children( ))==0: return target, missing for child in node.children( ): child_generation, child_missing=refresh(child, minimum, target) missing+=child_missing generations.append(child_generation) if len(missing)==0: return min(generations), missing else: return None, missing class BlockStore: “““ kv store: meta block index data block index blob index current generation garbage generation blobstore blobqueue blocks_per_blob blob_rewrite_threshold: rewrite blobs with fewer than this many referenced blocks new_block_generation_threshold ””” def_init_(self, ...): self.blobqueue=PriorityQueue( ) def put_meta_blocks(self, blockids, blocks, minimum_generation): “““ POST /metablocks””” return self._put_blocks(MetaNode, blockids, blocks, minimum_generation) def put_data_blocks(self, blockids, blocks, minimum_generation): “““ POST /datablocks””” return self._put_blocks(DataNode, blockids, blocks, minimum_generation) def get_current_generation(self): “““ GET /generation/current ””” # get current generation from kv store, cache for duration of request pass def get_garbage_generation(self): “““ GET /generation/garbage ””” # get from kv store pass def put_garbage_generation(self, generation): “““ PUT /generation/garbage ””” if generation<self.get_garbage_generation( ): # fail else: # put to kv store using optimistic update def new_block_minimum_gernation(self): “““Return suggested minimum generation for clients to use when adding new blocks.””” “““ GET /generation/new_block_minimum ””” # get new_block_generation_threshold from kv store return min( self.get_current_generation( )- self.new_block_generation_threshold, self.get_garbage_generation( )+1) def get_meta_block_generation(self, blockid): “““ GET /generation/metablocks/blockid ””” pass def put_meta_block_generation(self, blockid, minimum_generation): “““ PUT /generation/metablocks/blockid ””” node=MetaBlock(store=self, identifier=blockid) generation, missing=refresh_descendants( node, minimum_generation, self.current_generation( )) if generation is None: raise “not found” with node.optimistic_update( ) as update: update.set_generation(generation) update.commit( ) return “ok” def_put_blocks(self, node_class, blockids, blocks, minimum_generation): “““Add blocks to streamstore while maintaining that: All descendants of a node exist before adding that node. All descendants with genration less than minimum are refreshed. For each node, return an empty list if successful. Otherwise, return a list of nodes which must be added prior to adding that node.””” results=list( ) addable=list( ) for blockid, blockdata in blockids, blocks: node=node_class( store=self, identifier=blockid, new=True, data=blockdata) node.verify_data( ) generation, missing=refresh_descendants( node, minimum_generation, self.current_generation( )) if len(missing)==0: update=node.optimistic_create( ) update.set_generation(generation) addable.append((node, update)) results.append(missing) self._write_blocks(addable) return results # TODO: determine exact result format, should include block kind and id def_write_blocks(self, nodes, updates): concurrent_update=False blobs=coalesce_into_blobs(nodes) for blob in blobs: blobid=self.blobstore.put(blob) generation=self.get_current_generation( ) self._increment_current_generation( ) self.blobindex.put(blob) self.blobqueue.push(generation, blobid) for node in blob.nodes( ): update=updates[node] update.set_blob_id(blobid) try: update.commit( ) except ConcurrentUpdateException: pass def_gcblob(self, blob): “““Remove stale index entries for blocks in blob. Return list of blocks to keep.””” keep=list( ) for blockid in blob.blockids: node=Node(blockid) with node.optimistic_update( ) as update: if update.old==DELETED: update.abort( ) elif update.old.blob_identifier !=blob.identifier: update.abort( ) elif update.old.generation<=self.get_garbage_generation( ): update.delete( ) update.commit( ) else: update.abort( ) keep.append(node) if len(keep)==0: # no referenced blocks in this blob blob.delete( ) return keep def collect_garbage(self): while True: blob=blobqueue.pop( ) keep=self._gcblob(blob) if len(keep)<blob_rewrite_threshold: rewrite_blocks +=keep else: blobqueue.push(blob) if len(rewrite_blocks)>blocks_per_blob: # remove blocks_per_blob blocks and write a new blob # rerun gcblob on relevant blobs pass class StreamStore: “““ blockstore: stores meta and data blocks which expire based on generation number streamdb: stores stream info in transactional database with efficient min function update_gc_threashold: gc generation must change by this much before updating ””” def get_stream(self, stream_id): “““ GET /streams/stream_id ””” pass def put_stream(self, stream_id, root_block_id): “““ PUT /streams/stream_id ””” # stream_id is a unique id chosen by the client generation=blockstore.get_meta_block_generation(root_block_id) if generation is None: return {“missing”: [root_block_id]} with self.streamdb.transaction( ) as transaction: gc_generation=transaction.get_gc_generation( ) if generation<=gc_generation: raise ConcurrentUpdateException( ) transaction.put_stream(stream_id, root_block_id, generation) transaction.commit( ) return “ok” def delete_stream(self, stream_id): “““ DELETE /streams/stream_id ””” self.streamdb.delete_stream(stream_id) # could update gc generation here, but may be enough to only do it in # refresh_old_streams def_refresh_stream(self, streamid, root_block_id, minimum_generation): missing=self.blockstore.put_meta_block_generation( root_block_id, minimum_generation) self.put_stream(streamid, root_block_id) def_get_minimum_generation_stream(self): with self.streamdb.transaction( ) as transaction: streamid, root_block_id, generation=transaction.get_min_stream( ) old=transaction.get_gc_generation( ) new=generation−1 assert old>=new if new>old+self.update_gc_threashold: transaction.set_gc_generation(new) transaction.commit( ) # if transaction fails, retry self.blockstore.put_garbage_generation(new) else: transaction.abort( ) return streamid, root_block_id, generation def refresh_old_streams(self): “““Runs in a background service which continously refreshes the oldest streams in order to allow garbage collection to advance.””” while True: streamid, root_block_id, generation= self._get_minimum_generation_stream( ) minimum_generation= self.blockstore.new_block_minimum_generation( ) if generation< minimum_generation: self._refresh_stream( streamid, root_block_id, minimum_generation) else: time.sleep(60) class PriorityQueue: “““Relaxed consistency priority queue which can be implemented using a hyperdex namespace. Pop may not pop the exact min priority value, there may be lower priorities which were added recently.””” def_init_(self, store): self.store=store def push(self, priority, value): random=random_integer( ) self.store.put(key=(priority, random), value=value) def pop(self): while True: try: (priority, random), value=self.store.sorted_search( limit=1, maxmin=“min”) except NotFound: time.sleep(10) try: self.store.delete_if_exists(key=(priority, random)) except NotFound: continue # some other thread already popped this entry else: return value

Example pseudo code for implementing the garbage collector service on the client side appliance is provided below:

def sync_meta_block(block_id, store, server): for i in range(MAX_DEPTH+SYNC_RETRIES): minimum_generation=server.new_block_minimum_gernation( ) data=store.get_block(block_id) missing=server.put_meta_block(block_id, data, minimum_generation) if len(missing)==0: return “ok” else: t=StreamSync(store, server, minimum_generation) t.pushLeaves(missing[0]) def sync_stream(stream_id, root_block_id, store, server): “““push a stream to the server””” for i in range(MAX_DEPTH+SYNC_RETRIES): minimum_generation=server.new_block_minimum_gernation( ) missing=server.put_stream( stream_id, root_block_id, minimum_generation) if len(missing)==0: return “ok” else: assert len(missing)==1 t=StreamSync(store, server, minimum_generation) t.pushLeaves(missing[0]) class StreamSync: def_init_(self, store, server, minimum_generation): self.store =store self.server=server self.minimum_generation=minimum_generation self.work.meta=stack( ) self.work.data=stack( ) self.meta_batch_size # max blocks in meta batch request self.data_batch_size # max blocks in data batch request self.workers=WorkerPool(self._dowork) self.waiting=0 # count of waiting workers self.lock=Lock( ) self.nonempty=ConditionVariable( )

def pushLeaves(self, root_block_id): “““push leaves reachable from id to server””” self.work.meta.push(root_block_id) self.workers.start( ) self.workers.join( ) # wait for all workers to return

def_dowork(self): # worker function while True: kind, batch_ids=self._pop_work_batch( ) if kind is None:

return batch_blocks=self.store.get_blocks(kind, batch_ids) batch_result=self._put_blocks(kind, batch_ids, batch_blocks) for missing in batch_result: self._push_work(missing)

def_pop_work_batch(self): “““return a batch of work (block kind and list of block ids)””” while True: with self.lock: if (len(self.work.data)>=self.data_batch_size or len(self.work.meta)==0): return “data”, self.work.data.pop(self.data_batch_size) elif len(self.work.meta)>0: return “meta”, self.work.meta.pop(self.meta_batch_size) else: self.waiting+=1 if self.waiting==len(self.workers): assert len(self.work.meta)==0 assert len(self.work.data)==0 return None, None # all work is done self.nonempty.wait(self.lock) self.waiting−=1

def_push_work(self, missing): “““add work to the stack””” with self.lock: if missing.kind==“meta”: self.work.meta.push_all(missing.ids) if missing.kind==“data”: self.work.data.push_all(missing.ids) self.nonempty.notifyAll( )

def_put_blocks(self, kind, ids, blocks): “““push blocks to the server””” if kind ==“meta”: return self.server.put_meta_blocks( ids, blocks, self.minimum_generation) elif kind==“data”: return self.server.put_data_blocks(

ids, blocks, self.minimum_generation)

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A data stream synchronization method, comprising:
storing a data stream on a client side de-duplicating block store of a client device;
generating a data stream Merkle tree of the data stream;
storing a secure hash algorithm (SHA) key for the data stream Merkle tree, as well as the data stream Merkle tree on the client side de-duplicating block store;
recursively iterating through the data stream Merkle tree using an index of a snapshot Merkle tree of the client device that is stored on a cloud data center to determine missing Merkle nodes or missing data blocks which are present in the data stream Merkle tree but not present in the snapshot Merkle tree stored on the cloud data center; and
transmitting over a wide area network (WAN) the missing data blocks to the cloud data center.

2. The method according to claim 1, further comprising storing the missing Merkle nodes or missing data blocks in a child first, parent second arrangement.

3. The method according to claim 1, further comprising reconstructing the data stream Merkle tree on the cloud data center.

4. The method according to claim 1, wherein recursively iterating comprising walking a breadth of the data stream Merkle tree and pushing all non-existent Merkle nodes on a same level into a stack on the client side de-duplicating block store.

5. The method according to claim 4, further comprising transmitting the non-existent Merkle nodes in the stack over the WAN in multiple threads in parallel.

6. The method according to claim 4, further comprising popping the non-existent Merkle nodes from the client side de-duplicating block store to the cloud data center.

7. The method according to claim 5, wherein the non-existent Merkle nodes are transferred in such a way that a sequentially consistent relationship is maintained for Merkle roots.

8. The method according to claim 1, further comprising storing the missing data blocks as blobs in a blobstore.

9. The method according to claim 1, wherein transmitting over the WAN includes executing PUT operations for missing data blocks, wherein the PUT operations are idempotent because the PUT operations are defined with equivalent bulk variants allowing synchronization of a plurality of PUT operations for the same missing data blocks.

10. The method according to claim 1, wherein recursively iterating comprises:
creating a first directed acyclic graph of the data stream Merkle tree and the snapshot Merkle tree to determine data blocks reachable by a Merkle root; and
creating a second directed acyclic graph with the data blocks that are only present on the cloud data center removed, wherein the second directed acyclic graph has an initial height.

11. The method according to claim 10, wherein transmitting over the WAN includes:
transmitting leaves of the second directed acyclic graph so as to create a third directed acyclic graph that has a height of the initial height minus one; and
creating additional directed acyclic graphs and transmitting their leaves until the Merkle root is reached.

12. The method according to claim 1, wherein the missing data blocks are transmitted in a PUT operation that operates within a session and are placed into a session local cache on the cloud data store.

13. The method according to claim 12, wherein the missing data blocks of the session are stored together as an extent on the data store to preserve temporal locality of the missing data blocks as a spatial locality on the cloud data store.

14. The method according to claim 1, further comprising:
generating a SHA key value for each of the missing data blocks;
adding the SHA key values to the index.

15. The method according to claim 1, further comprising performing garbage collection by:
marking each block within the snapshot Merkle tree with a generation number;
refreshing the generation number of blocks of the snapshot Merkle tree which are referenced by at least one other block; and
deleting a block from a blockstore if the block is not referenced by at least one other block or does not have a current generation number; and
deleting a blob associated with the block from a blobstore.

16. The method according to claim 1, wherein the refreshing process is executed after each new data stream synchronization process.

17. A system, comprising:
a cloud data center comprising a cloud side de de-duplicating block store; and
a client side appliance that is coupled to the cloud data center over a wide area network (WAN), the client side appliance being configured to:
store a data stream on a client side de-duplicating block store of a client device;
generate a data stream Merkle tree of the data stream;
store a secure hash algorithm (SHA) key for the data stream Merkle tree, as well as the data stream Merkle tree on the client side de-duplicating block store;
recursively iterate through the data stream Merkle tree using an index of a snapshot Merkle tree of the client device that is stored on a cloud data center to determine missing Merkle nodes or missing data blocks which are present in the data stream Merkle tree but not present in the snapshot Merkle tree stored on the cloud data center; and
transmit over the wide area network (WAN) the missing data blocks to the cloud a center.

18. The method according to claim 17, wherein the cloud data center comprises a blockstore that stores the missing data blocks and a blobstore that stores blobs associated with the missing data blocks.

19. The method according to claim 18, wherein the blobs are associated with the blocks using SHA key values of the blocks that are stored in the index.
